(19) United States
(12) Patent Application Publication
(10) Pub. No.: US 2012/0155514 A1
(43) Pub. Date: Jun. 21, 2012

(54) DEVICE FOR EMPLOYING A PORTABLE COMMUNICATION DEVICE FOR ANTENNA ORIENTATION OPTIMIZATION

(75) Inventor: Jason Fruh, Lone Tree, CO (US)

(73) Assignee: ECHOSTAR TECHNOLOGIES L.L.C, Englewood, CO (US)

(21) Appl. No.: 12/972,002

(22) Filed: Dec. 17, 2010

(51) Int. Cl. H04B 1/38; H04L 27/00

(52) U.S. Cl. 375/219; 375/316

(57) ABSTRACT

An electronic device to be used in conjunction with a portable communication device to optimize an antenna orientation is presented. The device includes a first connector configured to be coupled with a signal line carrying a communication signal from an antenna, and a second connector configured to be engaged with the portable communication device. Also included in the electronic device is interfacing circuitry configured to generate digital data from the communication signal received from the antenna via the first connector, and to forward the digital data via the second connector to the portable communication device. The digital data includes data representative of a power level of the communication signal. An enclosure of the electronic device encloses the interfacing circuitry and provides mechanical support for the first and second connectors.

### BACKGROUND

Many communication antennas are “directional” in that they must be aligned in a desired direction, or must maintain a specific orientation, in order to transmit communication signals to, and/or receive communication signals from, a particular remote communication device or system. One example of such an antenna is a parabolic “dish” antenna typically associated with Direct Broadcast Satellite (DBS) and related satellite television systems. Such an antenna typically must be directed at the intended source satellite within a relatively small angular tolerance to allow the parabolic surface of the antenna to direct the received television signals to a low-noise block-converter (LNB) or similar signal-receiving circuitry of the antenna to capture the television programming reliably.

During the antenna installation process, a satellite system installer typically employs a signal meter to monitor the power, strength, or intensity of the satellite signal being received as the installer alters the angular orientation of the antenna to search for the orientation at which the received signal strength is maximized. To this end, the installer adjusts the antenna orientation in any or all of three angular directions: azimuth (i.e., left and right parallel to the horizon), elevation (i.e., up and down perpendicular to the horizon), and polarization or “skew” (i.e., rotationally about a central axis perpendicular to, and passing through, the dish portion of the antenna). In many cases, the meter is fairly substantial in size and weight, sometimes measuring nearly one foot across, and costing several hundred dollars. Further, some meters are designed to check only the power of the signal from the antenna by way of analog gauges, while more modern units provide more advanced functionality, such as displaying the desired azimuth, elevation, and skew for a selected satellite in response to a particular geographical location entered by the installer.

### BRIEF DESCRIPTION OF THE DRAWINGS

Many aspects of the present disclosure may be better understood with reference to the following drawings. The components in the drawings are not necessarily depicted to scale, as emphasis is instead placed upon clear illustration of the principles of the disclosure. Moreover, in the drawings, like reference numerals designate corresponding parts throughout the several views. Also, while several embodiments are described in connection with these drawings, the disclosure is not limited to the embodiments disclosed herein. On the contrary, the intent is to cover all alternatives, modifications, and equivalents.

FIG. 1 is a perspective view of an electronic device or fixture for employing a portable communication device to optimize an antenna orientation according to an embodiment of the invention.

FIG. 2 is a block diagram of a signal metering or peaking system according to an embodiment of the invention.

FIG. 3 is a block diagram of a signal metering system according to another embodiment of the invention.

FIG. 4A is a block diagram of an electronic device and associated portable communication device in a battery charging arrangement according to an embodiment of the invention.

FIG. 4B is a block diagram of an electronic device and associated portable communication device in a data collection arrangement according to an embodiment of the invention.

### DETAILED DESCRIPTION

The enclosed drawings and the following description depict specific embodiments of the invention to teach those skilled in the art how to make and use the best mode of the invention. For the purpose of teaching inventive principles, some conventional aspects have been simplified or omitted. Those skilled in the art will appreciate variations of these embodiments that fall within the scope of the invention. Those skilled in the art will also appreciate that the features described below can be combined in various ways to form multiple embodiments of the invention. As a result, the invention is not limited to the specific embodiments described below, but only by the claims and their equivalents.

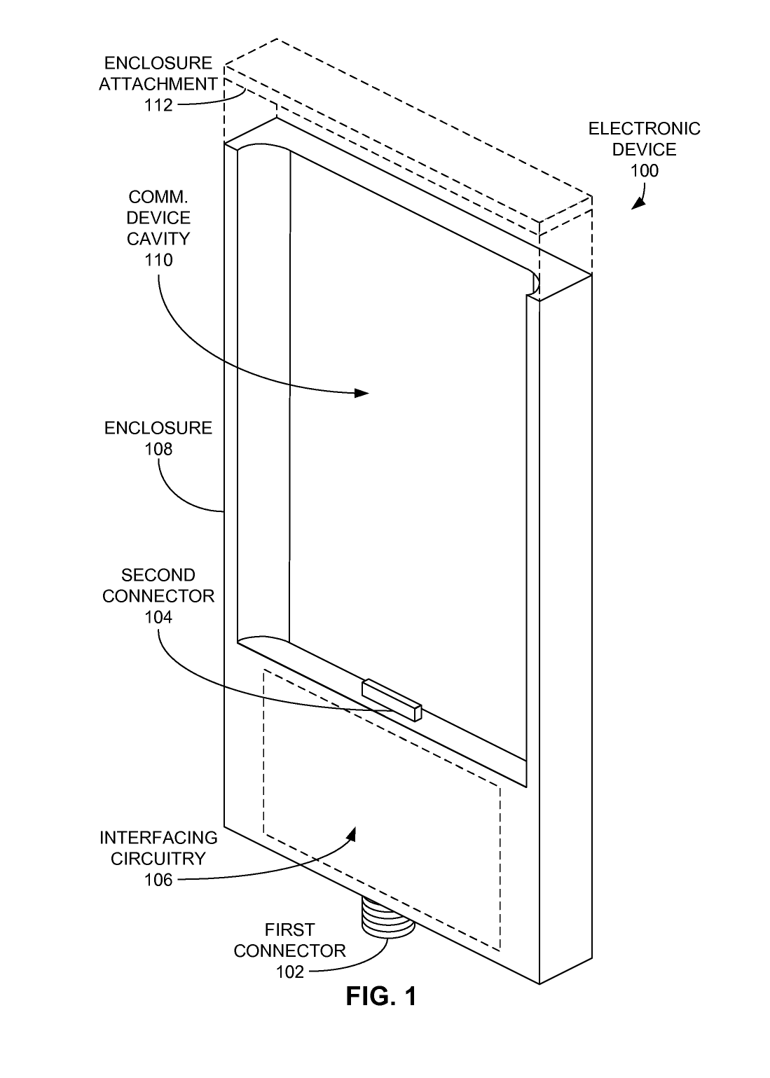

FIG. 1 illustrates an electronic device 100 according to an embodiment of the invention in which a portable communication device (not shown in FIG. 1) is utilized to perform a signal metering function, such as to measure the power, strength, or intensity of a communication signal being received by a communication antenna. An installer of the antenna may employ the information gathered by the metering function to determine the optimum orientation of the antenna at which the signal measurements are at a maximum. While FIG. 1 depicts one specific embodiment of the device 100, other implementations exhibiting differing physical characteristics may be devised while remaining within the scope of the invention as described hereinafter.

The electronic device or fixture 100 includes an enclosure 108 containing interfacing circuitry 106 configured to receive signals over a first connector 102. The interfacing circuitry 106 is also adapted to generate digital data representative of the received signals, and to forward the digital data over a second connector 104 to the portable communication device. The enclosure 106 provides mechanical support for the first connector 102 and the second connector 104, as well as protection for the interfacing circuitry 106. In one implementation, the enclosure 108 may be composed of one or more impact-resistant materials, such as rubber or a soft plastic, to protect the interfacing circuitry 106 and the portable communication device from physical damage.

In one embodiment, the enclosure 108 provides a communication device cavity 110 in which the portable communication device rests while being engaged with the second connector 104. Further, the second connector 104 is oriented such that the back surface of the portable communication device faces the enclosure 108, such that the front surface of the portable communication device that provides a display and a user interface faces outward from the enclosure 108. In some examples, the cavity 110 may be shaped to provide a close fit with a particular type of portable communication device. By allowing the enclosure 108 to extend beyond the communication device in each direction, the cavity 110 may thus serve to protect the portable communication device from damage if the electronic device 100 is accidentally dropped onto a table or other large, substantially flat surface. In another example, an enclosure attachment 112 may be attached to the top of the electronic device 100 to retain the communication device within the cavity 110, and to preserve the connection between the second connector 104 and the communication device.

Many physical variations of the electronic device 100 may be devised without departing from the scope of the invention. For example, the positions of the first connector 102 and the second connector 104 relative to the enclosure 108 may be altered to make the electronic device 100 useful in a variety of operational environments. In one case, while the type and positioning of the second connector 104 as shown in FIG. 1 may be suitable for an Apple® iPhone® or similar communication device, other positions for the second connector 104 within the cavity 110 may be employed for use with other communication devices. Also, the size and dimensions of the enclosure 108 may be altered to accommodate various sizes and types of communication devices, and to accommodate smaller or larger implementations of the interfacing circuitry 106. Further, the number of connectors employed on the electronic device 100 may be increased to enhance the functionality of the device 100, as is described in greater detail below.

While an iPhone® is specifically mentioned as an example of a portable communication device to be used in conjunction with the electronic device 100 of FIG. 1, other cellular phones supplied by various manufacturers, including various forms of “smart phones”, may serve as the portable communication device in other embodiments. Also, many types of personal digital assistants (PDAs) not specifically adapted to communicate via wireless signals may serve as the portable communication device. Generally, any portable electronic device capable of receiving digital data by way of a connector 104, and displaying or presenting related information to a user of the portable electronic device, may serve as the portable communication device discussed above.

Generally, as described in greater detail below, the electronic device 100 of FIG. 1, as well as other embodiments, may allow a portable communication device to provide an antenna installer at least a portion of the functionality normally associated with a typical communication signal tester. Such functionality may include, for example, the display of information representative of signal power or strength and/or other information related to a communication signal received at the antenna. By leveraging at least some of the display and processing capabilities of the portable communication device, the overall size and weight of a signal testing system may be reduced compared to typically available systems. Further, as many installers or users may already require the use of the portable communication device for other purposes, such as everyday verbal communications, the overall cost of a signal testing system employing the communication device may be lowered as well. Additional advantages may be recognized from the various implementations of the invention discussed in greater detail below.

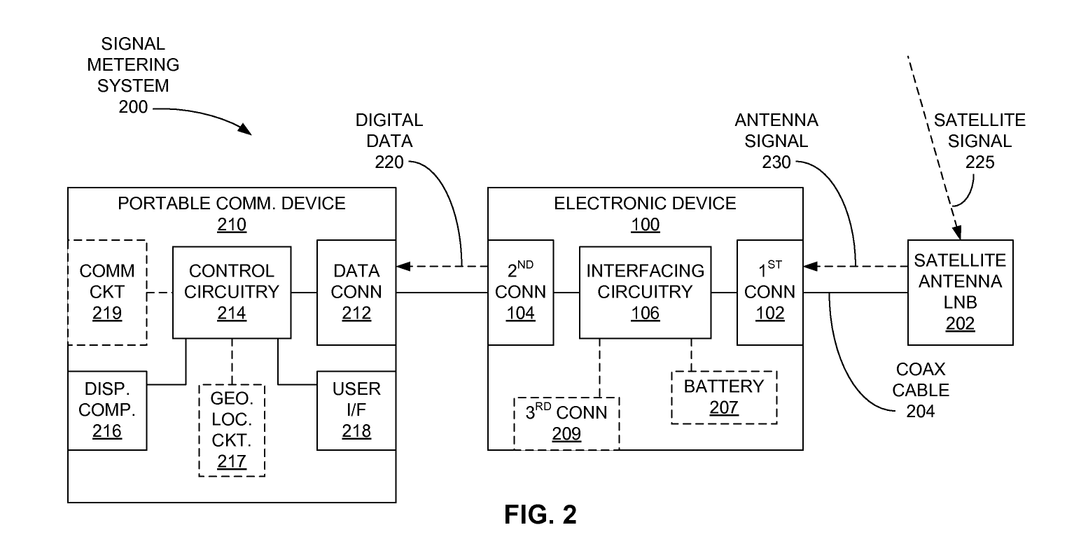

FIG. 2 illustrates by way of block diagram a signal metering system 200 according to an embodiment of the invention. As indicated in FIG. 1, the electronic device 100 is coupled via its second connector 104 to a portable communication device 210, such as a cellular phone, PDA, or other communication device. Via the first connector 102, the electronic device 100 is coupled with an a low-noise block-converter (LNB) mounted to a satellite television antenna, such as a parabolic, or “dish”, antenna, configured to receive one or more satellite television signals 225. Such an antenna is typically directional in nature, so that the strength of the satellite signal 225 as received at the LNB 202 is dependent upon the orientation of the antenna relative to the satellite serving as the source of the signals 225. Generally, the LNB 202 receives the satellite signals 225, down-converts the signals 225 from radio frequencies (RF) to intermediate frequencies (IF), and forwards the resulting antenna signals 230 over a coaxial cable 204. The LNB 202 may also perform filtering and other signal-conditioning functions. While the antenna signals 230 are normally carried to a television signal receiver or “set-top box”, in the implementations that follow, the coaxial cable 204 is coupled to the electronic device 100 via the first connector 102 for signal metering purposes. In this example, the first connector 102 may be an F-type coaxial cable connector, similar to that shown in FIG. 1, although other connector types may be utilized.

In this implementation, as well as those discussed hereinafter, the combination of the electronic device 100 and the portable communication device 210 helps determine a characteristic of the antenna signal 230, such as signal strength, power, or intensity. An installer or user may employ this information to determine an optimum orientation of the satellite antenna for proper reception of the satellite signals 225. Generally, this optimum orientation is the orientation of the antenna at which the power, strength, or intensity of the satellite signals 225 is maximized.

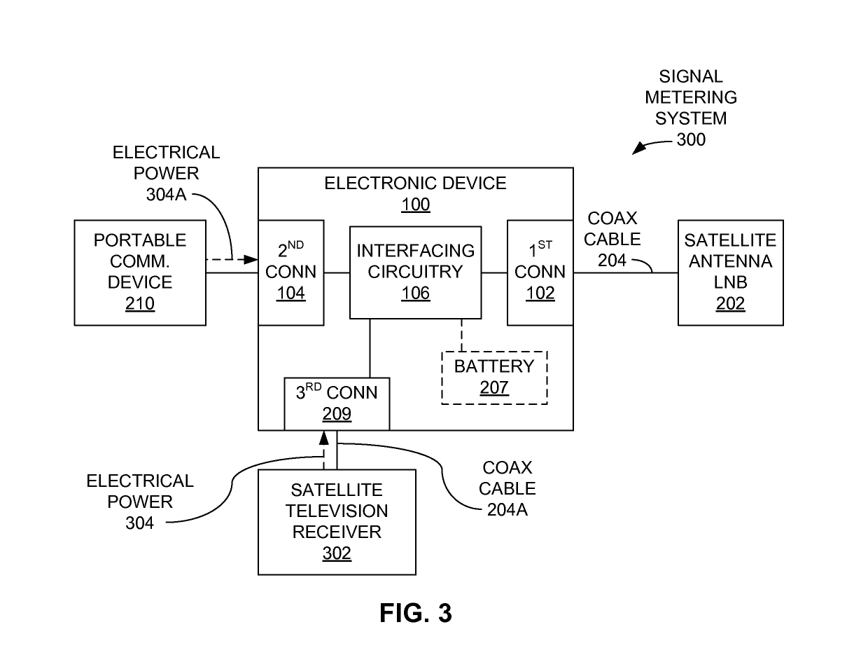

While the example of FIGS. 2 and 3 involve the use of a satellite television antenna with an attached LNB 202, other types of antennas and communication signals may benefit from various embodiments of the invention disclosed herein. In general, any wireless communication signal involving the use of an antenna, whether directional or omni-directional in nature, may be measured in terms of strength, power, intensity, or some other characteristic using the signal metering systems described herein. Also, antennas of other embodiments may employed for bidirectional communication, unlike the satellite antenna and associated LNB 202 of FIG. 2, which is employed strictly for reception of satellite signals 225 from one or more satellites.

To perform the signal measurements desired, interfacing circuitry 106 of the electronic device 100 is configured to receive the antenna signals 230 and generate digital data representative of some characteristic of the antenna signals 230, such as power, strength, or intensity, although other characteristics of the antenna signals 230 may be quantified in a similar manner. For example, the interfacing circuitry 106 may generate data representing the electrical voltage and/or current of the signals 230 as carried over the coaxial cable 204.

Any circuitry capable of performing the above functions associated with the interfacing circuitry 106 may be employed. Examples of such circuitry may include any one or all of amplifiers, filters, analog-to-digital converters (ADCs), and the like. The interfacing circuitry 106 may also include a processing unit, such as a microprocessor, microcontroller, or digital signal processor (DSP), executing software or firmware instructions stored on a non-transitory computer-readable storage medium for generating the digital data described above. In another example, the interfacing circuitry 106 may include strictly hardware circuitry capable of providing such functionality, or may employ some combination of hardware, firmware, and software elements. Any of the above circuitry may be embodied on one or more printed circuit boards (PCBs) held within the enclosure 108 of the electronic device 100.

The interfacing circuitry 106 forwards the generated digital data 220 via the second connector 104 to the portable communication device 210. In one example, the second connector 104 is a multi-conductor data connector adapted to carry the digital data 220 in a serial and/or parallel data format to the portable communication device 210. However, other types of connectors compatible with the particular portable communication device 210 to be employed in the signal metering system 200 may be utilized in other implementations.

In addition to the first connector 102, the second connector 104, and the interfacing circuitry 106 depicted in both FIGS. 1 and 2, other components may be incorporated within the electronic device 100. As shown in FIG. 2, the electronic device 100 may include one or more additional connectors, such as the third connector 209 illustrated therein. As is described more fully below, the third connector 209 may used for connection to an external power source, for the transmission of data generated within the portable communication device 210 to an external device, or for some other communication purpose.

As illustrated in FIG. 2, the electronic device 100 may also include a chargeable or non-chargeable battery 207 for supplying electrical power to any of the electronic device 100, the portable communication device 210, and the LNB 202. Other components, such as power supply circuitry driven by the battery 207, may be included in the electronic device 100, but are not described further herein to simplify the following discussion.

As mentioned earlier, the electronic device 100 forwards the digital data 220 via the second connector 104 to the portable communication device 210. As shown in FIG. 2, the portable communication device 210 includes a data connector 212, control circuitry 214, a display component 216, and a user interface 218. In some embodiments, the portable communication device 210 may include wireless communication circuitry 219 for communicating with other devices via wireless signals. Also possible incorporated in the communication device 210 may be geographical location circuitry 217 capable of determining the current geographical location of the communication device 210. Other components or devices, including but not limited to a battery, power supply circuitry, and audio generation circuitry, may be incorporated within the communication device 210 in other implementations.

The data connector 212 of the portable communication device 210 is configured to engage with the second connector 104 of FIGS. 1 and 2 so that the digital data 220 may be received and processed by the control circuitry 214. In this example, the second connector 104 is a multiple-conductor connector that mates with the second connector 104 for the reception of serial or parallel-formatted data. In another example, the data connector 212 may also present control data generated by the control circuitry 214 to the second connector 104 of the electronic device 100 so that the communication device 210 or the user thereof may direct the operation of the electronic device 100. For example, the control data may determine what forms or types of data generated in the electronic device 100 may be incorporated within the digital data 220 being provided to the portable communication device 210.

The control circuitry 214 is configured to communicate with, and possible control, any of the display component 216, the user interface 218, the geographical location circuitry 217, and the communication circuitry 219 of the communication device 210. The control circuitry 214 may include one or more processors, such as a microprocessor, microcontroller, or DSP, configured to execute instructions directing the processor to perform the functions associated with the control circuitry 214. In another implementation, the control circuitry 214 may be completely hardware-based logic circuitry, or may include a combination of hardware, firmware, and/or software elements.

The display component 216 may be any kind of visual interface, such as a liquid crystal display (LCD) screen configured to provide visual information to a user. The user interface 218 provides means by which the user may enter data, make selections, and provide other input to the communication device 210. The user interface 218 may include, for example, a set of user-actuated keys or buttons that, when pressed by the user in isolation or in combination, provide a desired input to the communication device 210. In another example, the user interface 218 may be implemented via a touch-screen interface incorporated with the display component 216 of the communication device 210. Other examples of either or both of the display component 216 and the user interface 218 may be utilized in other implementations.

In operation, the control circuitry 214 receives the digital data 220 via the data connector 212 and presents some indication of that data 220 to the user or installer via the display component 216. An audio generation circuit, including an audio speaker (not shown in FIG. 2) may also be used to relay information based on the received digital data 220 to the user. In one example, a stream of digital data 220 indicating the current power, strength, or intensity level of the antenna signals 230 over time as received at the electronic device 100 may be displayed numerically and/or graphically on the display component 216 for the benefit of the user. As the user alters the orientation of the satellite antenna and associated LNB 202, the power level of the antenna signal 230 may change, thus causing a corresponding change in the indication of the power level as displayed on the display component 216, thus providing the user timely feedback as to the optimum orientation for the antenna.

Other information related to the reception of the satellite signal 225 may also be received in the digital data 220 and forwarded to the display component 216 for presentation to the user. For example, in the case of multiple satellites residing in geosynchronous orbit about the earth, the satellite signal 225 may include an indication of the specific satellite which is sourcing the satellite signal 225. Such information may be included in the digital data 220 received at the communication device 210, which may then be presented to the user of the communication device 210.

In another implementation, the portable communication device 210 may also provide information that is useful for the antenna orientation task. For example, the portable communication device 210 may store in memory (not explicitly shown in FIG. 2) information relating various satellites of interest with the proper orientation of the antenna for a given geographical location. To that end, the user may enter some geographical indication, such as a ZIP code, street address, or latitude and longitude, and a desired satellite or broadcast network name via the user interface 218. In response, the control circuitry 214 may display a desired orientation, such as numerical values for the desired azimuth, elevation, and/or skew for the antenna so that satellite signals 225 sourced by the desired satellite may be received correctly at the LNB 202.

Additionally, instead of relying upon the user or installer to enter accurate geographical information regarding the current location of the antenna, the portable communication device 210 may employ the geographic location circuit 217 to make that determination without user guidance. In one example, the geographic location circuit 217 receives locating signals from multiple satellites of the Global Positioning System (GPS) to determine the location of the portable communication device 210 and, hence, the antenna. Other geographical location circuitry 217 configured to determine the location of the antenna may be utilized in alternate implementations.

To realize this functionality in a smart phone or similar device, the user may be able to download and install an application or applet capable of providing this functionality into the portable communication device 210. In one implementation, the control circuitry 214 may use the communication circuitry 219 shown in FIG. 2 to download the application for subsequent installation in the communication device 210. In one embodiment, the communication circuitry 219 includes transmitter and/or receiver circuits configured to facilitate normal audio and/or video communications normally associated with the communication device 210, as well as to access to the Internet, data applications, and the like. The application, along with any other communications, may be transmitted and/or received over any wireless network or communication link, such as a cellular communication network, a public switched telephone network (PSTN), the Internet or other wide-area network (WAN), an IEEE 802.11 (i.e., Wi-Fi) or other local-area network (LAN), a Bluetooth® communication link, or the like.

The communication circuit 219 may also be utilized to transfer information regarding the signal metering system 200 to an external device, such as a communication node or data collection center. Such information may include, for example, some or all of the digital data 220 received at the portable communication device 210, a summary of the data 220, or data generated by the control circuitry 214 in response to the digital data 220 and/or user input supplied via the user interface 218. The device or unit receiving this data may utilize the data to determine how well the antenna is aligned with the desired satellite sourcing the received satellite signals 225, the overall performance of the user or installer involved, and other information. The user of the signal metering system 200 may also employ the communication device 210 to communicate with supervisors or other personnel for guidance during the antenna installation or peaking process, as a user would normally employ the communication device 210 to communication with other people.

In order to perform its duties, the LNB 202 requires electrical power, which is typically received at the LNB 202 from a satellite television receiver or set-top box via the coaxial cable 204 during normal operation. In one example, a battery 207 installed in the electronic device 100 may supply the necessary power over the coaxial cable 204 in lieu of a set-top box so that the LNB 202 may provide the required antenna signals 230 to the electronic device 100 for measuring.

In some examples, other components of, or associated with, the signal metering system may supply the required power to the satellite antenna LNB 202, as well as the electronic device 100. FIG. 3 provides an example of a signal metering system 300 in which the electronic device 100 provides a third connector 209 for the receipt and transfer of electrical power 304 from a satellite television receiver or set-top box 302 over a second coaxial cable 204A. That power may then be employed by the electronic device 100, and also be forwarded via the first coaxial cable 204 to the LNB 202. In one arrangement, the third connector 209 may be an F-type connector similar to the first connector 102, and may reside next to the first connector 102 at the bottom end of the enclosure 108 of the device 100, although other locations for the third connector 209 are also possible. The power 304 provided by the receiver 302 may also be used to charge a battery 207 of the electronic device 100 for later operation in the absence of the receiver 302. Under some circumstances, that power 304 may also be supplied via the second connector 104 of the electronic device 100 to operate the portable communication device 210 in cases in which the battery of the communication device 210 is low on charge.

In another example shown in FIG. 3, the portable communication device 210, by way of a battery supplied therein, may supply electrical power 304A by way of its data connector 212 to the second connector 104 of the electronic device 100. That power may be applied to both the electronic device 100 and the LNB 202 (via the first coaxial cable 204).

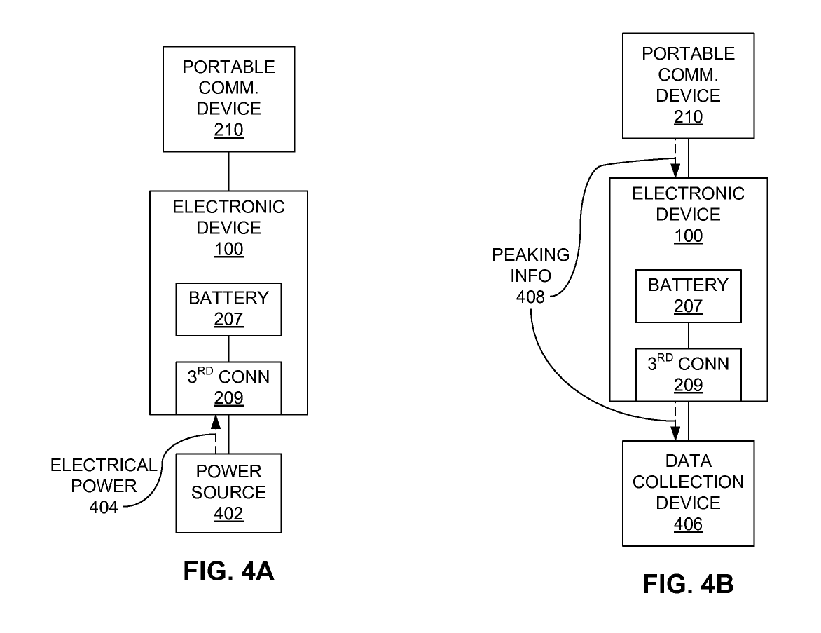

Whether or not coupled with the LNB 202, the combination of the electronic device 100 and the portable communication device 210 may be coupled to an external device or system via the third connector 209 to perform other tasks. For example, in the block diagram of FIG. 4A, a power source, such as a cigarette lighter or a computer, may be coupled with the third connector 209 to charge the battery 207 of the electronic device 100. Depending on the nature of the power source 402, the third connector 209 may be a coaxial connector, a power connector (such as for a direct-current (DC) power supply), a Universal Serial Bus (USB) connector, or another standard or non-standard connector.

In the example of FIG. 4B, the third connector 209 of the electronic device 100 is coupled with a data collection device 406. While in this configuration, the portable communication device 210 may transmit by way of the electronic device 100 to the data collection device 406 information that was generated in the communication device 210 based on the digital data 220. One example of such information is peaking information 408, which may include data demonstrating the progression of values of the digital data 220 as the user or installer adjusted the orientation of the antenna. The information 408 may also include any user input provided via the user interface 218 of the communication device 210. Based on this information 408, the data collection device 406 may determine a performance level or rating associated with the peaking task of that particular antenna. In one example, the data collection device 406 may also charge an internal battery 207 of the electronic device 100 in anticipation of another antenna peaking/metering operation. The third connector 209 may be a USB connector, parallel data connection, or any other data interface employable between the electronic device 100 and the data collection device 406.

At least some embodiments as described herein thus facilitate the signal metering or peaking of a communication signal received via an antenna by leveraging the processing and display capabilities of a portable communication device, such as a cell phone or PDA, in conjunction with an interfacing device that is directly connectable to the antenna circuitry via a cable or similar connection. Use of a readily available communication device for such a purpose tends to reduce the size, weight, and cost typically associated with peaking meters. In some implementations, the interfacing device or fixture provides a measure of protection for the portable communication device against accidental impacts. Further, the use of the portable communication device for such a purpose may be facilitated via an application that may be downloaded to, and executed on, the communication device.

While several embodiments of the invention have been discussed herein, other implementations encompassed by the scope of the invention are possible. For example, while various embodiments have been described largely within the context of satellite antennas and associated receiver circuitry, other antennas engaging in wireless directional signal transmission and/or reception, such as terrestrial (“over-the-air”) signal antennas, may benefit from various aspects of the functionality of the metering systems described above to similar effect. In addition, aspects of one embodiment disclosed herein may be combined with those of alternative embodiments to create further implementations of the present invention. Therefore, while the present invention has been described in the context of specific embodiments, such descriptions are provided for illustration and not limitation. Accordingly, the proper scope of the present invention is delimited only by the following claims and their equivalents.

What is claimed is:

1. An electronic device for employing a portable communication device to optimize an antenna orientation, the device comprising:
a first connector configured to be coupled with a signal line carrying a communication signal from an antenna;
a second connector configured to be engaged with a portable communication device;
interfacing circuitry configured to generate digital data from the communication signal received from the antenna via the first connector, and to forward the digital data via the second connector to the portable communication device, wherein the digital data comprises data representative of a power level of the communication signal; and
an enclosure configured to enclose the interfacing circuitry and to provide mechanical support for the first and second connectors.

2. The electronic device of claim 1, wherein:
the interfacing circuitry is configured to receive electrical power from the portable communication device via the second connector, and to transfer the electrical power via the first connector over the signal line to the antenna.

3. The electronic device of claim 1, further comprising:
a third connector configured to receive electrical power from a communication signal receiver via a second signal line;
wherein the interfacing circuitry is configured to receive the electrical power from the third connector, and to transfer the electrical power via the first connector over the signal line to the antenna.

4. The electronic device of claim 1, wherein:
the enclosure is configured to enclose a battery; and
the interfacing circuitry is configure to transfer electrical power from the battery, and to transfer the electrical power via the first connector over the signal line to the antenna.

5. The electronic device of claim 4, further comprising:
a third connector configured to receive electrical power;
wherein the interfacing circuitry is configured to receive the electrical power from the third connector and to charge the battery using the electrical power.

6. The electronic device of claim 1, wherein:
the enclosure is configured to cover at least one surface of the portable communication device when the portable communication device is engaged with the second connector.

7. The electronic device of claim 1, wherein:
the enclosure is configured to prevent contact of the portable communication device with a planar surface of greater dimensions than the enclosure when the portable communication device is engaged with the second connector.

8. The electronic device of claim 1, wherein:
the enclosure comprises means for maintaining engagement of the portable communication device with the second connector.

9. The electronic device of claim 1, wherein:
the digital data comprises data representative of a signal strength of the communication signal.

10. The electronic device of claim 1, wherein:
the digital data comprises data representative of at least one of a voltage of the signal line and a current of the signal line.

11. The electronic device of claim 1, further comprising:
a third connector configured to be connected with a data collection device;
wherein the interfacing circuitry is configured to receive second digital data based on the digital data from the portable communication device via the second connector, and to transmit the information via the third connector to the data collection device.

12. The electronic device of claim 11, wherein:
the second digital data includes data indicating a geographical location of the portable communication device.

13. An electronic fixture for utilizing a portable communication device to peak a satellite antenna signal, the electronic fixture comprising:
a first coaxial cable connector configured to connect with a coaxial cable carrying a satellite communication signal from a satellite antenna;
a second connector configured to be engaged with a portable communication device;
interfacing circuitry configured to generate digital data based on the satellite antenna signal received via the first coaxial cable connector, and to forward the digital data via the second connector to the portable communication device, wherein the digital data comprises data representative of a signal level of the satellite communication signal; and
an enclosure configured to enclose the interfacing circuitry, wherein the first coaxial cable connector and the second connector extend from an exterior of the enclosure, and wherein the enclosure defines a cavity within which the portable communication device resides while the portable communication device is engaged with the second connector.

14. The electronic fixture of claim 13, further comprising:
an enclosure attachment configured to attach to the enclosure to retain the portable communication device within the cavity when the portable communication device is coupled with the second connector.

15. The electronic fixture of claim 13, wherein, when the portable communication device is engaged with the second connector:
a long axis of the enclosure is aligned with a long axis of the portable communication device; and
a back surface of the portable communication device faces a surface of the enclosure.

16. The electronic fixture of claim 13, wherein:
the enclosure comprises an impact-resistant material; and
when the portable communication device is engaged with the second connector, the enclosure prevents contact between the portable communication device and an external planar surface having physical dimensions larger than the physical dimensions of the enclosure.

17. A portable communication device, comprising:
communication circuitry configured to transmit and receive wireless communication signals;
a connector configured to engage with a connector of an electronic device, wherein the electronic device is configured to provide at the connector digital data representing a characteristic of a satellite antenna signal received at the electronic device from a satellite antenna;
control circuitry configured to process the digital data to generate an indication of the characteristic of the satellite antenna signal; and
a display component configured to visually display the indication of the characteristic of the satellite antenna signal.

18. The portable communication device of claim 17, further comprising:
a user interface configured to receive a selection of a satellite and a geographical location of the portable communication device;
wherein the control circuitry is configured to generate information for orienting a satellite antenna to receive satellite signals from the selected satellite, and to provide the information to the display component for presentation to the user.

19. The portable communication device of claim 17, further comprising:
a user interface configured to receive a selection of a satellite; and
geographical location circuitry configured to determine a geographical location of the portable communication device;
wherein the control circuitry is configured to generate information for orienting a satellite antenna to receive satellite signals from the selected satellite, and to provide the information to the display component for presentation to the user.

20. The portable communication device of claim 17, wherein:
the control circuitry is configured to generate information regarding accuracy of orienting a satellite antenna to receive satellite signals, wherein the information is based on the digital data, and to forward the information via the connector to the electronic device for transfer to a data collection system.
